(19) United States
(12) Patent Application Publication
(10) Pub. No.: US 2008/0038105 A1
(43) Pub. Date: Feb. 14, 2008

(54) Stacking And Transport Vehicle For Container Transshipment Facilities And Container Warehouses

(76) Inventors: Otto Weis, Oberpleichfeld (DE); Klaus-Peter Franke, Dettelbach (DE)

Correspondence Address: WILLIAM COLLARD;COLLARD & ROE, P.C., 1077 NORTHERN BOULEVARD, ROSLYN, NY, 11576, US

(21) Appl. No.: 11/578,683

(22) PCT Filed: Apr. 11, 2005
(86) PCT No.: PCT/EP05/03767

§ 371 Date: Oct. 17, 2006

(30) Foreign Application Priority Data
Apr. 17, 2004 (DE) 102004018667.7

(51) Int. Cl. B66C 23/28

(52) U.S. Cl. 414/561

(57) ABSTRACT

The invention relates to stacking and transport vehicle for container transshipment facilities and container warehouses, consisting of the vehicle frame with wheels, drive units, a telescoping lifting arm with a hydraulic cylinder between the vehicle and the lifting arm, and a driver's cabin, whereby the one side of the telescoping lifting arm is disposed in a bearing block, above the front wheel, so as to pivot on an articulation; the hydraulic cylinders are disposed between the vehicle and the telescoping lifting arm, approximately in the center of the vehicle; a clear space is situated in the rear region of the vehicle, with the center of gravity above the wheels, in which space containers can be transported, hanging from the spreader, wherein the vehicle is provided with a spreader with twist locks for grasping containers having different dimensions; the one side of the telescoping lifting arm is disposed so as to pivot in a bearing block vertically above the front wheel, on an articulation; the hydraulic cylinders are disposed approximately in the center of the vehicle, between the vehicle and the telescoping part of the telescoping lifting arm that is not displaceable; a clear space is situated in the rear region of the vehicle with the center of gravity above the wheels, in which space the containers can be transported hanging longitudinally relative to the vehicle from the spreader. The invention has the advantage that the containers can be transported longitudinally between container rows that can stand very close, at a relatively high speed, and with a low space requirement, whereby the vehicle is suitable for stacking the containers at container transshipment facilities and container warehouses, and for loading vehicles of all types with containers and unloading them.

The invention relates to a stacking and transport vehicle in accordance with the preamble of the first claim.

Such special vehicles are suitable for stacking, sorting, and moving containers of different sizes in container transshipment facilities or container warehouses, and, as necessary, loading and unloading incoming and outgoing vehicles at these facilities and warehouses.

Container transshipment facilities and container warehouses, as they exist in harbors, at transshipment facilities between rail and road vehicles, require vehicles that are able to stack containers on top of one another at a high speed and with great reliability, to load and unload vehicles of different type and construction, and to transport the containers within the transshipment facility or the warehouse. In this connection, there is furthermore the requirement that transport takes place at a high speed, whereby the narrowest alleys possible, for transport of the containers, are present between the rows of containers for reasons of space. The narrower the alleys between the containers can be built, the more containers a storage facility can contain. The same holds true for the height of the containers to be stacked. Thus, vehicles must be available that move containers through narrow alleys, whereby the containers must be stacked to a great height.

So-called high-reach stackers are known for stacking containers.

In DE 197 43 871 A1, a high-reach stacker is described that is primarily suitable for use in inland terminals, whereby containers must be transported from container stacks to ships, rail, and trucks, and vice versa.

It is true that this vehicle is able to reach inaccessible stack locations because of its telescope mechanism, but the vehicle cannot drive along narrow alleys, so that they are not suitable for large storage facilities with tight storage space, such as those represented by transshipment facilities at harbors.

For these transshipment facilities, it is usual to use so-called straddle carriers, with which containers are moved within harbor facilities. The width of these vehicles is significantly greater than that of the containers to be transported, so that the alleys between the containers must amount to 2.5 times the container width, and this results in a significant space requirement in warehouses. Furthermore, in addition to these costly vehicles, cranes are also required for transporting the containers.

From U.S. Pat. No. 4,838,438, a vehicle of this type is known, with which the containers can be moved longitudinally between the container stacks, and set down onto container stacks.

A typical vehicle of this type is described in DE 203 11 886.3, as a portal lift truck having an electrical wheel drive, whereby the electrical wheel drive is necessary in order to keep the width of the vehicle low and to achieve great maneuverability. Such vehicles can accelerate very quickly, thereby achieving rapid transport of containers within the storage facility, so that the dock times of ships can be kept low.

From WO 80/02264, a vehicle for lifting and transporting containers is evident, which has a detection unit for the container, a telescoping lifting arm, a driver's cabin, and hydraulic cylinders on both sides, whereby the hydraulic cylinders are disposed in the center of the vehicle and the telescoping lifting arm is situated in front of the axle of the vehicle, on the driver's cabin. This vehicle does not have a spreader. Because the vehicle grasps and transports the containers crosswise, this vehicle is not suitable for transporting containers along narrow alleys between containers. There is no rotation possibility for the containers. The device for grasping the container must be changed, depending on the size of the containers to be transported, and this makes the work in warehouses holding containers of different sizes significantly more difficult. Because of the constantly low sitting position of the driver, it is not easily possible to grasp and transport the containers by way of the longitudinal side.

WO 95/00357 shows a loading device for containers that are grasped at the front and at the rear, on the side, and are set down on a chassis over their entire length, whereby the chassis can be secured by means of lateral supports and can be an integral part of a transport vehicle. Such a vehicle, which represents a tractor trailer, is not suitable for moving in alleys between containers, because of its large turning circle. Furthermore, loading and unloading along the length of the vehicle is not possible.

A utility vehicle for transport of containers is evident from EP 0 238 878, which also represents a type of tractor trailer, whereby containers that stand next to the vehicle can be grasped and pivoted onto the loading surface by means of the pivoting boom. The vehicle is equipped with five axles and is suitable for transporting containers at high speed over long distances, whereby stacking of containers is not possible with this vehicle. Therefore this vehicle is at most suitable for picking containers up from a container transshipment facility or delivering them there.

A device for loading and unloading ships, particularly inland ships in inland harbors, is evident from DE 198 11 361 C2, which device has a driver's cabin in the center, over which a telescoping lifting arm arches, at the end of which there is a spreader with which containers can be stacked. Since the containers are grasped crosswise to the direction of travel, the vehicle is not suitable for moving along narrow container alleys.

DE 2824 851 C2 shows a drivable loading device for containers, with which containers of different sizes and composition can be grasped and stacked, whereby a telescoping lifting arm and driver's cabin are present. However, because of its width, the vehicle is not suitable for moving along narrow container alleys.

A transport vehicle that grasps containers with a lifting arm that is disposed behind the driver's cabin and sets them down onto a loading surface is evident from DE 36 02 694 A1. A tilting lifting arm is used for grasping. The vehicle is suitable for grasping containers and transporting them over long distances. Because of the arrangement of the driver's cabin and the lack of telescoping ability of the lifting arm as well as the lack of a spreader, this vehicle is not suitable for transporting containers in a warehouse, stacking them, or loading and unloading vehicles.

A mobile cargo system that is suitable as a transport device and freight transshipment device, for example for freight aircraft, is evident from DE 196 34 711 A1. Because a lifting arm is disposed on the side of the vehicle, a broad vehicle is formed, which is not suitable for transport in alleys and can only drive to very specific, unambiguous stacking facilities. In order to change the position of the driver's cabin, a complex mechanism is required, which is complicated in its function and expensive in its implementation.

It is a disadvantage of the state of the art as indicated above that the known container transport vehicles are not able to move along narrow alleys between the containers, or that existing container stacking devices and vehicles are either not able to safely and reliably stack containers to a great height, or cannot move along narrow alleys between containers.

It is therefore the task to develop a vehicle that can transport containers of different sizes in narrow alleys having a width of at most 1.5 times the container width, between rows of containers, and, at the same time, is able to grasp containers from stacks having a great height of container stacks, and to reliably and quickly transport them in container transshipment facilities and container warehouses.

This task is accomplished by means of a stacking and transport vehicle in accordance with the characteristics of the first claim.

The dependent claims reproduce advantageous embodiments of the invention.

The solution according to the invention provides a stacking and transport vehicle for container transshipment facilities and container warehouses, which serves for grasping containers having different dimensions, whereby a telescoping lifting arm is disposed on a bearing block above the front wheels, so as to pivot up and down on an articulation, and hydraulic cylinders between the vehicle and the telescoping lifting arm, which are disposed approximately in the center of the vehicle. It is advantageous to dispose the telescoping lifting arm outside the center and on one side of the vehicle, since the driver's cabin is disposed on the other side. This means that torsion forces act on the telescoping lifting arm, as the container is being picked up, which forces are balanced out by way of the hydraulic cylinders disposed symmetrical to the container.

In the rear region of the vehicle, with the center of gravity above the wheels of one or more rear axles, there is a clear space in which the container is transported, hanging from the spreader. In order to guarantee that the container is transported securely and free of movement, a centering mechanism is disposed in the center of the vehicles, which holds the container in place. The centering mechanism can be rigid parts into which the container is introduced, and held by rollers, for example. However, it is also advantageous to wedge the container between two hydraulic devices during transport, in such a manner that two holder elements move towards the lower corners of the container as soon as the container has reached its transport position in the vehicle, and hold the container in place in the vehicle. The clear space between the container and the vehicle can represent a surface.

In an advantageous embodiment, however, the vehicle has only two beams on which one, two, or more axles for the wheels are situated, whereby the interstice between the beams does not have to be closed.

It is advantageous if the driver's cabin is disposed in the first third of the vehicle. In this way, it is possible for the driver to have an overview both of the driving procedure and of the loading procedure. Furthermore, it is necessary and advantageous if the driver's cabin is adjustable in height, so that the driver can always have a good and reliable overview of loading/unloading and stacking procedures, and can perform them well and reliably.

It is furthermore advantageous if the height of the bearing block is greater than the height of the container to be transported. Furthermore, it is advantageous if the end of the telescoping lifting arm, on which the spreader is situated, is structured in angled manner, so that the spreader is situated precisely in the middle above the container to be transported, despite the fact that the telescoping lifting arm is disposed on the side.

In order to be able to use the stacking and transport vehicle universally for stacking and taking on containers, a combined rotation, pivot, and lateral adjustment device is situated on the end of the telescoping lifting arm, with which device the container can be grasped and moved crosswise or longitudinally relative to the vehicle, so that it can be loaded onto the vehicle longitudinally. Furthermore, it is advantageous if the wheels of the vehicle are equipped with electrical drives. In order to achieve great stability of the vehicle outside of the alleys, the rear wheels of the second axle can be extended, in addition to the counterweight.

In the following, the invention will be explained in greater detail using ten figures and an exemplary embodiment. The figures show:

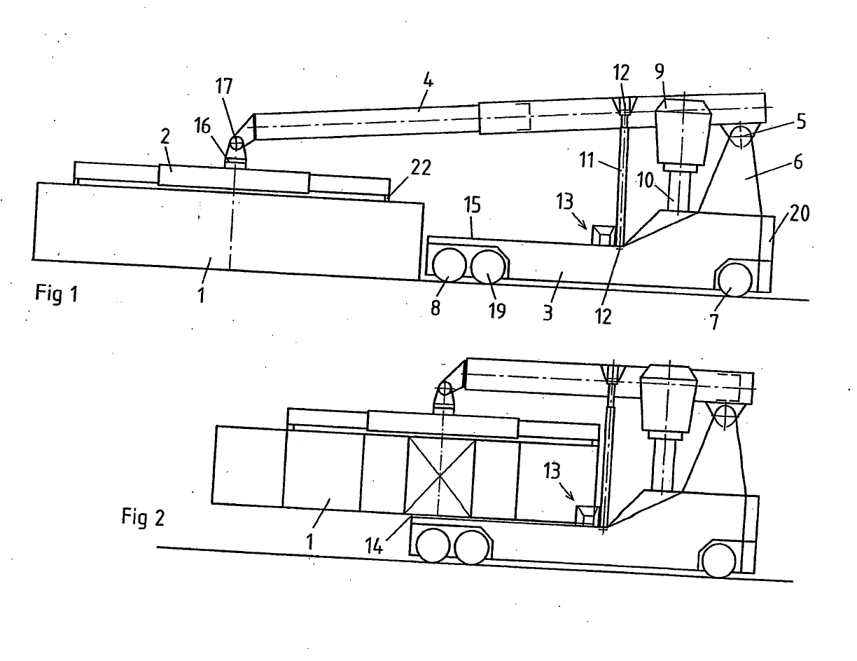

FIG. 1: stacking and transport vehicle when picking a 49-foot container up from the ground

FIG. 2: view of the stacking and transport vehicle when transporting containers of different sizes

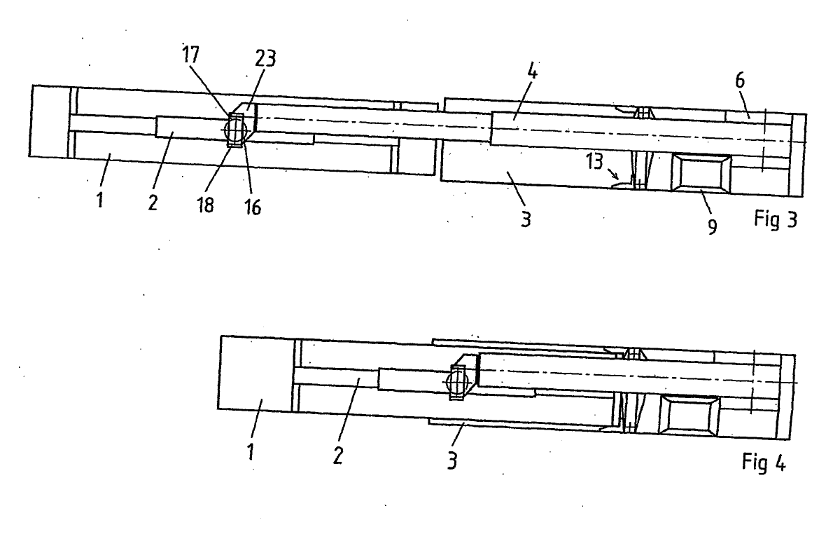

FIG. 3: top view of FIG. 1

FIG. 4: top view of the stacking and transport vehicle of FIG. 2

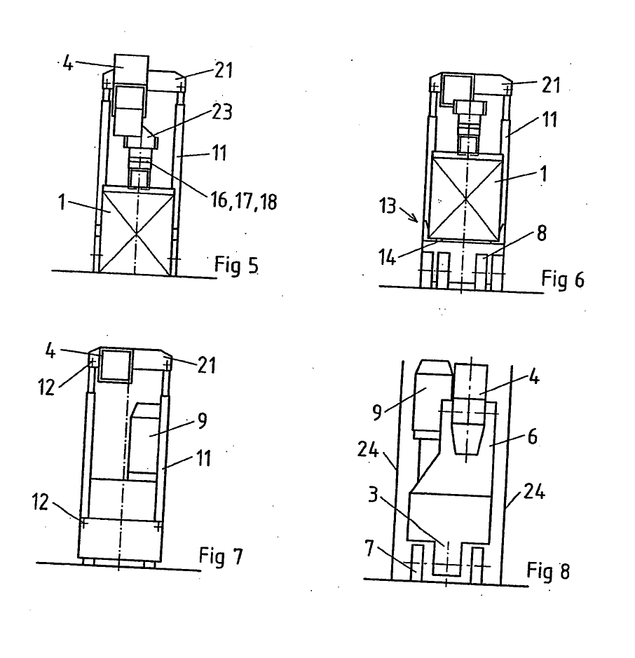

FIG. 5: side view of FIG. 1

FIG. 6: side view of FIG. 2

FIG. 7: cross-section with telescoping mast on one side and hydraulic cylinder(s)

FIG. 8: view from the front, with driver's cabin raised

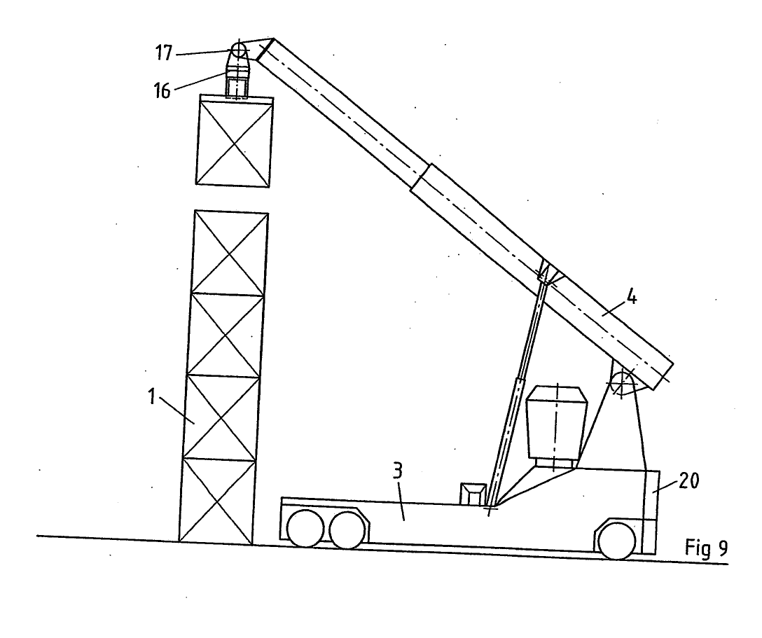

FIG. 9: view of the vehicle while stacking containers

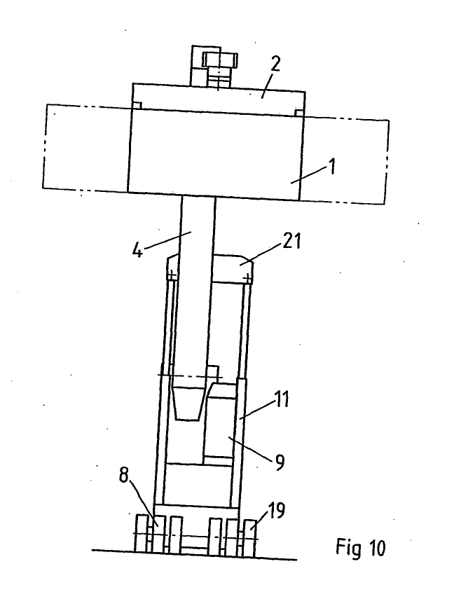

FIG. 10: side view of the vehicle with a 20-foot container in the raised position and wheels extended.

FIG. 1 shows the stacking and transport vehicle 3, which has a front axle with steerable wheels 7 and two rear axles with wheels 8, 19, whereby the bearing block 6 is disposed above the front wheels 7, which block has the articulation 5 on which the telescoping lifting arm 4 is disposed. The telescoping lifting arm 4 is moved up and down by means of two hydraulic cylinders 11, which are connected both with the vehicle 3 and with the lifting arm 4 by means of articulations 12. The driver's cabin 9 is disposed between the hydraulic cylinders 11 and the fork-shaped bearing block 6, which cabin can be moved up and down by way of a scissors mechanism 10, for example, so that it is possible for the driver to watch transport and warehousing procedures. Furthermore, the spreader 2 is disposed on the telescoping lifting arm 4; its manner of construction makes it possible to grasp containers 1 of different sizes with the twist locks 22.

FIG. 2 shows the vehicle 3 after it has been loaded with a container 1, whereby containers 1 having different dimensions such as crosswise 20 ft, 40 ft, 49 ft are indicated symbolically. As FIG. 2 shows, the clear space 14, below which there is a surface 15, as shown in FIG. 1, is situated below the container 1, which is transported in suspended manner. The container 1 is held and guided at its lower corners, in the region of the hydraulic cylinders 11, by means of the container centering mechanism 13.

It is evident from FIGS. 3 and 4 that in the present case, the left side of the vehicle 3 carries the telescoping lifting arm 4 and the bearing block 6, whereby the front end of the telescoping lifting arm 4 a combined rotation 16, pivot 17, and lateral adjustment device 18 is built onto a bracket part 23, so that the container 1 can be grasped by the spreader 2 vertically from above, over the middle. The driver's cabin 9, which is adjustable in height, is disposed on the right side of the vehicle 3.

FIGS. 5, 6, 7, 8 show the stacking and transport vehicle 3 in different side views.

FIG. 5 shows a container 1 being picked up from the ground, whereby it is evident that only the telescoping lifting arm 4 is disposed asymmetrically, and the spreader is built on in the middle, by way of a bracket part 23 and a combined rotation 16, pivot 16, and lateral adjustment device 18.

FIG. 6 shows the transport state of a container 1, which is transported hanging above the clear space 14, on the spreader 2. The container centering mechanism 13 on the underside of the container 1 can also be seen.

FIG. 7 shows the hydraulic cylinder 11, the viewing conditions from the driver's cabin 9, the connection of the hydraulic cylinder 11 with its articulations 12 to the side arms 21, and the latter to the telescoping lifting arm 4, in a sectional view.

FIG. 8 shows the stacking and transport vehicle 3 in a side view from the front, with the steerable wheels 7, the asymmetrically disposed bearing block 6, the telescoping lifting arm 4, the raised driver's cabin 9, in a narrow alley 24 having 15. times the container width.

FIGS. 9 and 10 show the vehicle 3 while stacking containers 1 to a great height, and in different views, whereby the vehicle 3 is shown with the wheels 19 extended.

The vehicle according to the invention has the advantage that the containers 1 can be transported longitudinally between container rows that can stand very close, at a relatively high speed, and with a low space requirement, whereby the vehicle 3 is suitable for stacking the containers at container transshipment facilities and container warehouses, and for loading vehicles of all types with containers and unloading them.

### LIST OF REFERENCE SYMBOLS USED

1. container

2. spreader

3. stacking and transport vehicle

4. telescoping lifting arm

5. articulation between 4 and 6

6. bearing block

7. front wheel

8. rear wheel

9. driver's cabin

10. support of the driver's cabin

11. hydraulic cylinder between 3 and 4

12. articulation of 11

13. container centering mechanism on 3

14. clear space between 3 and 1

15. surface for clear space 15

16. rotation device on 4

17. pivot device

18. lateral adjustment device

19. adjustable wheels

20. counterweight

21. side arm

22. twist locks

23. bracket part

24. delimitation line, narrow alley

1. Stacking and transport vehicle (3) for container transshipment facilities and container warehouses, consisting of the vehicle frame with wheels (7, 8, 19), drive units, a spreader (2) with twist locks (22) for grasping containers (1) having different dimensions, a telescoping lifting arm (4) with a hydraulic cylinders (11) between the vehicle (3) and the lifting arm (4), and a driver's cabin (9), whereby
the one side of the telescoping lifting arm (4) is disposed in a bearing block (6), above the front wheel (7), so as to pivot on an articulation (12),
the hydraulic cylinders (11) are disposed between the vehicle (3) and the telescoping lifting arm (4), approximately in the center of the vehicle (3),
a clear space (14) is situated in the rear region of the vehicle (2), with the center of gravity above the wheels (8, 19), in which space containers (3) can be transported, hanging from the spreader (2).

2. Stacking and transport vehicle (3) according to claim 1, wherein centering mechanisms (13) for containers (1) are disposed approximately in the center of the vehicle (3).

3. Stacking and transport vehicle (3) according to claim 2, wherein the driver's cabin (9) is disposed between the bearing block (6) and the hydraulic cylinders (11).

4. Stacking and transport vehicle (3) according to claim 3, wherein the driver's cabin (9) is adjustable in height.

5. Stacking and transport vehicle (3) according to claim 1, wherein the height of the bearing block (6) is greater than or equal to the height of the containers (1) to be transported.

6. Stacking and transport vehicle (3) according to claim 1, wherein the distance between the axle of the front wheel (7) and the articulation (5) of the telescoping lifting arm (4) corresponds to twice the height of a container (1).

7. Stacking and transport vehicle (3) according to claim 1, wherein the telescoping lifting arm (4) is disposed outside the center.

8. Stacking and transport vehicle (3) according to claim 1, wherein a bracket part is built onto the front end of the telescoping lifting arm (4).

9. Stacking and transport vehicle (3) according to claim 1, wherein the spreader (2) is disposed on the telescoping lifting arm (4) with a device that can rotate (16), pivot (17), and is laterally adjustable (18), with the bracket part 23.

10. Stacking and transport vehicle (3) according to claim 1, wherein the spreader (2) is adjustable in its length.

11. Stacking and transport vehicle (3) according to claim 1, wherein the wheels (7, 8, 19) can be extended and retracted.
